(19) United States
(12) Patent Application Publication
(10) Pub. No.: US 2022/0372283 A1
(43) Pub. Date: Nov. 24, 2022

(54) RESIN COMPOSITION AND SHAPED PRODUCT

(71) Applicant: ASAHI KASEI KABUSHIKI KAISHA, Tokyo (JP)

(72) Inventors: Miki TOKUYAMA, Tokyo (JP); Shinsuke MOCHIZUKI, Tokyo (JP); Nozomi INAGAKI, Tokyo (JP)

(73) Assignee: ASAHI KASEI KABUSHIKI KAISHA, Tokyo (JP)

(21) Appl. No.: 17/664,046

(22) Filed: May 19, 2022

(30) Foreign Application Priority Data
May 19, 2021 (JP) 2021-084919

(51) Int. Cl. C08L 71/12; C08L 77/06

(52) U.S. Cl. CPC C08L 71/12; C08L 77/06

(57) ABSTRACT

Provided are a polyamide/polyphenylene ether resin composition that has excellent fluidity, heat resistance, and surface impact strength while also having excellent repeated processability and a shaped product that includes this resin composition. The resin composition contains: (a) a polyamide; (b) a polyphenylene ether; (c) a compatibilizer for the (a) polyamide and the (b) polyphenylene ether; and (d) a polyhydric alcohol including at least two hydroxyl groups and having a number-average molecular weight (Mn) of less than 500. The content of the (d) polyhydric alcohol is 0.3 parts by mass to 5 parts by mass relative to 100 parts by mass, in total, of the (a) polyamide and the (b) polyphenylene ether. A ratio of terminal amino group concentration relative to terminal carboxyl group concentration (terminal amino group concentration/terminal carboxyl group concentration) in the (a) polyamide is 0.3 to 0.5. The (a) polyamide forms a continuous phase.

### TECHNICAL FIELD

The present disclosure relates to a resin composition and a shaped product.

### BACKGROUND

Polyphenylene ethers are widely used due to having excellent mechanical properties, electrical properties, and heat resistance while also having excellent dimensional stability, but have poor shaping processability when used by themselves.

In order to resolve this issue, a technique of compounding a polyamide has been proposed in Patent Literature (PTL) 1 and the like. Such polymer alloys have been the subject of various enhancements and are now being used in a variety of applications as metal substitutes in electrical and electronic components, automotive components, and so forth.

On the other hand, polyamides have conventionally been used in numerous fields such as automotive components, mechanical components, and electrical and electronic components due to excelling in terms of mechanical strength, heat resistance, chemical resistance, and so forth. In particular, polyamide 6,6 has conventionally been used in relay blocks that are installed inside engine compartments of automobiles, but has suffered from a problem of increased dimensional change upon absorption of water.

For this reason, there has recently been gradual movement toward using polyamide/polyphenylene ether resin compositions in place thereof. PTL 2 discloses a technique of, in a composition that contains a polyphenylene ether, a polyamide, and a vinyl aromatic-olefin block copolymer, controlling the polyphenylene ether and the vinyl aromatic-olefin block copolymer to a specific dispersion diameter. Moreover, PTL 3 discloses a composition that contains a polyphenylene ether, a polyamide, and a water-soluble substance having specific water solubility.

### CITATION LIST

### Patent Literature

PTL 1: JP S45-997 B
PTL 2: JP H1-79258 A
PTL 3: JP 2005-231219 A

### SUMMARY

At present, there is a trend toward adopting more complicated shapes for automotive components, mechanical components, electrical and electronic components, and the like, and there is also movement toward reduction of size and thickness thereof. Among such components, SMT-compatible components, representative examples of which include relay blocks and connectors, have in particular been subject to increased shape complexity, compactization, and thinning in recent years. At the same time, there is also demand for materials to be designed such as to be reusable from a viewpoint of sustainability of resources. Accordingly, while it is also desirable for materials to have fluidity in injection molding, heat resistance, surface impact strength, and repeated processability, none of the techniques proposed in PTL 1 to 3 has been adequate for providing a material that retains fluidity enabling excellent shapeability for thin-walled components while also simultaneously having excellent heat resistance, surface impact strength, and repeated processability.

Accordingly, an object of the present disclosure is to provide a polyamide/polyphenylene ether resin composition that has excellent fluidity, heat resistance, and surface impact strength while also having excellent repeated processability and a shaped product that includes this resin composition.

As a result of diligent investigation conducted with the aim of solving the problem set forth above, the inventors discovered that by adding a specific polyhydric alcohol and a compatibilizer for a polyamide and a polyphenylene ether to a polyamide/polyphenylene ether resin composition in which a specific polyamide is used, it is possible to solve the problem set forth above. In this manner, the inventors arrived at the present disclosure.

Specifically, primary features of the present disclosure are as follows.

[1] A resin composition comprising:

(a) a polyamide;

(b) a polyphenylene ether;

(c) a compatibilizer for the (a) polyamide and the (b) polyphenylene ether; and

(d) a polyhydric alcohol including at least two hydroxyl groups and having a number-average molecular weight (Mn) of less than 500, wherein

content of the (d) polyhydric alcohol is 0.3 parts by mass to 5 parts by mass relative to 100 parts by mass, in total, of the (a) polyamide and the (b) polyphenylene ether,

a ratio of terminal amino group concentration relative to terminal carboxyl group concentration in the (a) polyamide, in terms of terminal amino group concentration/terminal carboxyl group concentration, is 0.3 to 0.5, and

the (a) polyamide forms a continuous phase.

[2] The resin composition according to [1], wherein content of the (a) polyamide is 40 parts by mass to 90 parts by mass and content of the (b) polyphenylene ether is 10 parts by mass to 60 parts by mass relative to 100 parts by mass, in total, of the (a) polyamide and the (b) polyphenylene ether.

[3] The resin composition according to [1] or [2], wherein the (a) polyamide has a formic acid relative viscosity (VR) of 30 to 40.

[4] The resin composition according to any one of [1] to [3], wherein the (a) polyamide is polyamide 6,6.

[5] The resin composition according to any one of [1] to [4], wherein the (d) polyhydric alcohol is dipentaerythritol.

[6] The resin composition according to any one of [1] to [5], further comprising, as (e) an impact modifier, either or both of a block copolymer including at least one block of mainly aromatic vinyl monomer units and at least one block of mainly conjugated diene monomer units and a hydrogenated product of the block copolymer.

[7] A shaped product comprising the resin composition according to any one of [1] to [6].

[8] The shaped product according to [7], wherein the shaped product is a component for an automotive electrical or electronic application.

According to the present disclosure, it is possible to obtain a polyamide/polyphenylene ether resin composition that has excellent fluidity, heat resistance, and surface impact strength while also having excellent fluidity and surface impact strength even after repeated extrusion, and also to provide a shaped product including this resin composition.

### DETAILED DESCRIPTION

The following provides a detailed description of the presently disclosed matter.

[Resin Composition]

A resin composition according to a present embodiment contains: (a) a polyamide; (b) a polyphenylene ether; (c) a compatibilizer for the (a) polyamide and the (b) polyphenylene ether; and (d) one or a plurality of polyhydric alcohols each including at least two hydroxyl groups and having a number-average molecular weight (Mn) of less than 500, wherein the content of the (d) polyhydric alcohol is 0.3 parts by mass to 5 parts by mass relative to 100 parts by mass, in total, of the (a) polyamide and the (b) polyphenylene ether, a ratio of terminal amino group concentration relative to terminal carboxyl group concentration (terminal amino group concentration/terminal carboxyl group concentration) in the (a) polyamide is 0.3 to 0.5, and the (a) polyamide forms a continuous phase.

As a result of the resin composition according to the present embodiment having the configuration set forth above, it is possible to provide a resin composition that, when used in the form of an injection molded product, for example, can inhibit the occurrence of bleed-out while also simultaneously having excellent fluidity, heat resistance, and surface impact strength. Moreover, the resin composition according to the present embodiment can display retention of fluidity and surface impact strength even upon repeated use.

[(a) Polyamide]

The (a) polyamide (hereinafter, also referred to simply as the “(a) component”) according to the present embodiment is not specifically limited so long as it includes an amide bond (—NH—C(═O)—) in a repeating unit of a polymer main chain.

Polyamides are generally obtained through ring-opening polymerization of a lactam, polycondensation of a diamine and a dicarboxylic acid, polycondensation of an w-aminocarboxylic acid, or the like. However, no limitation is made to resins obtained by these methods.

The lactam may, more specifically, be ε-caprolactam, enantholactam, ω-laurolactam, or the like.

The diamine may be broadly classified as an aliphatic diamine, an alicyclic diamine, or an aromatic diamine. Specific examples of the diamine include aliphatic diamines such as tetramethylenediamine, hexamethylenediamine, undecamethylenediamine, dodecamethylenediamine, tridecamethylenediamine, 2,2,4-trimethylhexamethylenediamine, 2,4,4-trimethylhexamethylenediamine, 5-methylnonamethylenediamine, 1,9-nonanediamine, 2-methyl-1,8-octanediamine, ethylenediamine, propylenediamine, 1,4-butanediamine, 1,6-hexanediamine, 1,8-octanediamine, 1,10-decanediamine, 1,12-dodecanediamine, 3-methyl-1,5-pentanediamine, 2,2,4-trimethyl-1,6-hexanediamine, 2,4,4-trimethyl-1,6-hexanediamine, and 5-methyl-1,9-nonanediamine, 1,3-bisaminomethylcyclohexane, 1,4-bisaminomethylcyclohexane, m-phenylenediamine, p-phenylenediamine, m-xylylenediamine, and p-xylylenediamine.

The dicarboxylic acid may be broadly classified as an aliphatic dicarboxylic acid, an alicyclic dicarboxylic acid, or an aromatic dicarboxylic acid. Specific examples of the dicarboxylic acid include adipic acid, suberic acid, azelaic acid, sebacic acid, dodecanedioic acid, 1,1,3-tridecanedioic acid, 1,3-cyclohexanedicarboxylic acid, terephthalic acid, isophthalic acid, naphthalenedicarboxylic acid, and dimer acids.

The aminocarboxylic acid may, more specifically, be ε-aminocaproic acid, 7-aminoheptanoic acid, 8-aminooctanoic acid, 9-aminononanoic acid, 11-aminoundecanoic acid, 12-aminododecanoic acid, 13-aminotridecanoic acid, or the like.

In the present embodiment, any copolymerized polyamide obtained by polycondensation of one or a mixture of two or more of these lactams, diamines, dicarboxylic acids, and ω-aminocarboxylic acids may be used.

Moreover, it is also possible to suitably use a product that is obtained by polymerizing any of these lactams, diamines, dicarboxylic acids, and ω-aminocarboxylic acids in a polymerization reactor until a low molecular weight oligomer stage is reached and then carrying out polymerization to reach a high molecular weight in an extruder or the like.

In particular, examples of the (a) polyamide that can suitably be used in the present embodiment include polyamide 6, polyamide 6,6, polyamide 4,6, polyamide 11, polyamide 12, polyamide 6,10, polyamide 6,12, polyamide 6/6,6, polyamide 6/6,12, polyamide MXD,6 (MXD: m-xylylenediamine), polyamide 6,T, polyamide 9,T, polyamide 6,1, polyamide 6/6,T, polyamide 6/6,1, polyamide 6,6/6,T, polyamide 6,6/6,1, polyamide 6/6,T/6,I, polyamide 6,6/6,T/6,I, polyamide 6/12/6,T, polyamide 6,6/12/6,T, polyamide 6/12/6,1, and polyamide 6,6/12/6,1.

Furthermore, a polyamide obtained by copolymerizing a plurality of polyamides among those described above in an extruder or the like can also be used. Of the polyamides described above, one or more polyamides selected from aliphatic polyamides among polyamide 6, polyamide 6,6, polyamide 4,6, polyamide 11, and polyamide 12; and semi-aromatic polyamides among polyamide 9,T, polyamide 6/6,T, polyamide 6,6/6,T, polyamide 6,6/6,1, and polyamide MXD,6 are preferable, and one or more polyamides selected from polyamide 6,6, polyamide 6, polyamide 9,T, and polyamide 6,6/6,1 are more preferable.

Formic acid relative viscosity (VR) can be used as an indicator of the molecular weight of the (a) polyamide according to the present embodiment. The formic acid relative viscosity (VR) is the relative viscosity of a formic acid solution of the (a) polyamide and is the relative viscosity determined when the viscosity of the formic acid solution of the (a) polyamide is compared to the viscosity of formic acid itself. A larger VR value is evaluated as indicating higher molecular weight.

Measurement of VR is implemented in accordance with ASTM-D789. Specifically, a value measured at 25° C. using a solution obtained by dissolving the (a) polyamide with a concentration of 8.4 mass % in 90 mass % formic acid (10 mass % water) is taken to be the VR value.

VR of the (a) polyamide is preferably not less than 25 and not more than 45, more preferably not less than 25 and not more than 40, and even more preferably not less than 30 and not more than 40.

When VR of the (a) polyamide is 25 or more, mechanical properties tend to improve. On the other hand, when VR of the (a) polyamide is 45 or less, fluidity tends to improve while maintaining mechanical properties, and shaping processability also tends to improve.

The (a) polyamide according to the present embodiment may be a mixture of a plurality of polyamides having different VR values.

Terminal groups of the (a) polyamide become involved in reaction with the (b) polyphenylene ether. In general, a polyamide has an amino group or a carboxyl group as each terminal group, with a higher concentration of terminal carboxyl groups typically leading to reduction of impact resistance and improvement of fluidity. Conversely, a higher concentration of terminal amino groups leads to improvement of impact resistance and reduction of fluidity.

In the present embodiment, a ratio of terminal amino group concentration relative to terminal carboxyl group concentration (terminal amino group concentration/terminal carboxyl group concentration) in the (a) polyamide is 0.3 to 0.5. This ratio is preferably 0.3 to 0.45, and more preferably 0.3 to 0.4. When the ratio is within any of these ranges, it is possible to improve fluidity and impact resistance of the composition and also fluidity and surface impact strength upon repeated extrusion.

The terminal amino group concentration of the (a) polyamide according to the present embodiment is preferably 20 μmol/g to 80 μmol/g, more preferably 20 μmol/g to 60 μmol/g, and even more preferably 20 μmol/g to 50 μmol/g. By setting the terminal amino group concentration within any of the ranges set forth above, it is possible to improve fluidity and impact resistance of the composition and also fluidity and surface impact strength upon repeated extrusion.

The terminal carboxyl group concentration of the (a) polyamide according to the present embodiment is preferably 40 μmol/g to 150 μmol/g, more preferably 60 μmol/g to 120 μmol/g, and even more preferably 70 μmol/g to 110 μmol/g. By setting the terminal carboxyl group concentration within any of the ranges set forth above, it is possible to improve fluidity and impact resistance of the composition and also fluidity and surface impact strength upon repeated extrusion.

Adjustment of these terminal groups in the (a) polyamide can be performed by a commonly known method. In one example of such a method, one or more selected from diamine compounds, monoamine compounds, dicarboxylic acid compounds, monocarboxylic acid compounds, and the like is added in polymerization of the (a) polyamide such as to have a specific terminal concentration.

Although the terminal amino group and terminal carboxyl group concentrations referred to in the present embodiment can be measured by various methods, it is preferable in terms of precision and simplicity to determine the concentrations through integrated values for characteristic signals corresponding to these terminal groups in ¹H-NMR. For example, it is recommended that the specific method of quantification of terminal group concentration of a semi-aromatic polyamide is in accordance with a method described in the examples of JP H7-228689 A.

In a case in which a semi-aromatic polyamide is used as the (a) polyamide according to the present embodiment, it is preferable that 10% to 95% of terminal groups of molecule chains of the semi-aromatic polyamide are capped by a terminal-capping agent. The lower limit for the proportion of terminal groups of molecule chains that are capped by the terminal-capping agent (terminal capping percentage) is more preferably 40%, and even more preferably 60%. A terminal capping percentage of 10% or more can reduce viscosity change during melt-shaping of the resin composition according to the present embodiment and tends to have an effect of yielding excellent external appearance of an obtained shaped product and excellent physical properties such as stability of heat resistance during processing. The upper limit for the terminal capping percentage is more preferably 90%. A terminal capping percentage of 95% or less tends to have an effect of yielding excellent impact resistance of the composition and excellent surface appearance of a shaped product.

The terminal capping percentage of a semi-aromatic polyamide serving as the (a) polyamide according to the present embodiment can be determined according to the following formula (1) by measuring the number of terminal carboxyl groups, the number of terminal amino groups, and the number of terminal groups capped by the terminal-capping agent that are present in the polyamide resin.

Terminal capping percentage (%)=[(α−β)/α]×100 (1)

(In the formula, α represents the total number of terminal groups of molecule chains (units=moles; normally equal to two times the number of polyamide molecules), and β represents the total number of carboxyl group terminals and amino group terminals that remain uncapped.)

No specific limitations are placed on the terminal-capping agent so long as it is a monofunctional compound that is reactive with a terminal amino group or carboxyl group of the polyamide. A monocarboxylic acid or monoamine is preferable in terms of reactivity, stability of capped terminals, and so forth, and a monocarboxylic acid is more preferable in terms of ease of handling and so forth. Other examples of compounds that can be used as the terminal-capping agent include acid anhydrides, monoisocyanates, monoacid halides, monoesters, monoalcohols, and the like.

No specific limitations are placed on monocarboxylic acids that can be used as the terminal-capping agent so long as they are reactive with an amino group. Examples thereof include aliphatic monocarboxylic acids such as acetic acid, propionic acid, butyric acid, valeric acid, caproic acid, caprylic acid, lauric acid, tridecanoic acid, myristic acid, palmitic acid, stearic acid, pivalic acid, and isobutyric acid; alicyclic monocarboxylic acids such as cyclohexanecarboxylic acid; aromatic monocarboxylic acids such as benzoic acid, toluic acid, α-naphthoic acid, β-naphthoic acid, methylnaphthoic acid, and phenylacetic acid; and any mixtures thereof. Of these monocarboxylic acids, acetic acid, propionic acid, butyric acid, valeric acid, caproic acid, caprylic acid, lauric acid, tridecanoic acid, myristic acid, palmitic acid, stearic acid, and benzoic acid are preferable, and acetic acid and benzoic acid are particularly preferable in terms of reactivity, stability of capped terminals, cost, and so forth.

No specific limitations are placed on monoamines that can be used as the terminal-capping agent so long as they are reactive with a carboxyl group. Examples thereof include aliphatic monoamines such as methylamine, ethylamine, propylamine, butylamine, hexylamine, octylamine, decylamine, stearylamine, dimethylamine, diethylamine, dipropylamine, and dibutylamine; alicyclic monoamines such as cyclohexylamine and dicyclohexylamine; aromatic monoamines such as aniline, toluidine, diphenylamine, and naphthylamine; and any mixtures thereof. Of these monoamines, butylamine, hexylamine, octylamine, decylamine, stearylamine, cyclohexylamine, and aniline are preferable, and butylamine, hexylamine, and octylamine are particularly preferable in terms of reactivity, boiling point, stability of capped terminals, cost, and so forth.

In the present embodiment, a transition metal other than iron and/or a halogen may be provided in the resin composition with the aim of further improving stability of heat resistance imparted to the resin composition through the (a) polyamide.

The type of transition metal is not specifically limited, but is preferably copper, cerium, nickel, or cobalt, and particularly preferably copper. Of halogens, bromine or iodine can preferably be used.

The preferred amount of the transition metal other than elemental iron is not less than 1 mass ppm and less than 200 mass ppm when the entire resin composition is taken to be 100 mass %. This amount is more preferably not less than 5 mass ppm and less than 100 mass ppm. Likewise, the preferred amount of the halogen is not less than 500 mass ppm and less than 1,500 mass ppm, with an amount of not less than 700 mass ppm and less than 1,200 mass ppm being more preferable.

No specific limitations are placed on the method by which the transition metal and/or halogen is added to the resin composition. For example, a method in which the transition metal and/or halogen is added as a powder during melt-kneading of the polyamide/polyphenylene ether resin composition, a method in which the transition metal and/or halogen is added during polymerization of the polyamide, a method in which master pellets having the transition metal and/or halogen added to the polyamide in high concentration are produced and then these master pellets are added to the resin composition, or the like may be adopted. Of these methods, the method involving addition during polymerization of the polyamide and the method involving production and subsequent addition of master pellets having the transition metal and/or halogen added to the polyamide in high concentration are preferred methods.

Besides the transition metal and/or halogen described above, commonly known organic stabilizers can also be used without any issues in the present embodiment.

Examples of organic stabilizers that may be used include hindered phenol-based antioxidants, representative examples of which include Irganox 1098 (produced by Ciba Specialty Chemicals), phosphorus-based processing heat stabilizers, representative examples of which include Irgafos 168 (produced by Ciba Specialty Chemicals), lactone-based processing heat stabilizers, representative examples of which include HP-136 (produced by Ciba Specialty Chemicals), sulfur-based heat resistance stabilizers, and hindered amine-based light stabilizers. Of these organic stabilizers, a hindered phenol-based antioxidant, a phosphorus-based processing heat stabilizer, or a combination thereof is more preferable.

The preferred amount of these organic stabilizers is 0.001 parts by mass to 1 part by mass relative to 100 parts by mass of the (a) polyamide.

[(b) Polyphenylene Ether]

Specific examples of the (b) polyphenylene ether (hereinafter, also referred to simply as the “(b) component”) according to the present embodiment include poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether), and also polyphenylene ether copolymers such as a copolymer of 2,6-dimethylphenol with another phenol (for example, a copolymer with 2,3,6-trimethylphenol or a copolymer with 2-methyl-6-butylphenol such as described in JP S52-17880 B).

Of these examples, poly(2,6-dimethyl-1,4-phenylene ether), a copolymer of 2,6-dimethylphenol and 2,3,6-trimethylphenol, or a mixture thereof is particularly preferable as the polyphenylene ether.

The (b) polyphenylene ether can be produced by a commonly known method without any specific limitations. For example, the (b) polyphenylene ether can be produced by a method described in U.S. Pat. No. 3,306,874 A in which production is performed through oxidative polymerization of 2,6-xylenol, for example, using a complex of a cuprous salt and an amine as a catalyst, or a production method described in any of U.S. Pat. Nos. 3,306,875 A, 3,257,357 A, 3,257,358 A, JP S50-51197 A, JP S52-17880 B, and JP S63-152628 A.

The reduced viscosity (measured for 0.5 g/dL chloroform solution at 30° C. using an Ubbelohde-type viscometer) of the (b) polyphenylene ether according to the present embodiment is preferably 0.30 dL/g to 0.80 dL/g, more preferably 0.35 dL/g to 0.75 dL/g, and most preferably 0.38 dL/g to 0.55 dL/g. When the reduced viscosity of the (b) polyphenylene ether is within any of these ranges, this is preferable in terms of characteristics such as impact resistance and heat resistance being excellent.

A blend of two or more polyphenylene ethers having different reduced viscosities can also preferably be used as the (b) polyphenylene ether according to the present embodiment.

Moreover, various commonly known stabilizers can suitably be used in order to stabilize the (b) polyphenylene ether. Examples of stabilizers that may be used include metal-based stabilizers such as zinc oxide and zinc sulfide and organic stabilizers such as hindered phenol-based stabilizers, phosphorus-based stabilizers, and hindered amine-based stabilizers. The preferred amount of these stabilizers is less than 5 parts by mass relative to 100 parts by mass of the (b) polyphenylene ether.

Commonly known additives and the like that can be added to the (b) polyphenylene ether may also be added in an amount of less than 10 parts by mass relative to 100 parts by mass of the (b) polyphenylene ether.

[Quantitative Ratio of (a) Polyamide and (b) Polyphenylene Ether]

In the present embodiment, the preferred contents of the (a) polyamide and the (b) polyphenylene ether are 40 parts by mass to 90 parts by mass of the (a) polyamide and 10 parts by mass to 60 parts by mass of the (b) polyphenylene ether when the total amount of both the (a) polyamide and the (b) polyphenylene ether is taken to be 100 parts by mass. Ranges of 50 parts by mass to 75 parts by mass for the (a) polyamide and 25 parts by mass to 50 parts by mass for the (b) polyphenylene ether are more preferable, and ranges of 50 parts by mass to 70 parts by mass for the (a) polyamide and 30 parts by mass to 50 parts by mass for the (b) polyphenylene ether are even more preferable. When the content ratio of (a) and (b) is within any of these ranges, this is preferable because of the excellent balance of heat resistance, fluidity, and surface impact strength.

Note that the contents of these components in the resin composition can be determined by Fourier-transform infrared spectroscopy (FT-IR) using a calibration curve method.

In the present embodiment, the total content of the (a) polyamide and the (b) polyphenylene ether in the resin composition is preferably 50 mass % or more, more preferably 60 mass % or more, and even more preferably 70 mass % or more when the entire resin composition is taken to be 100 mass %.

[Distribution of (a) Polyamide and (b) Polyphenylene Ether]

In the resin composition according to the present embodiment, a phase that contains the (a) polyamide constitutes a continuous phase. On the other hand, a phase that contains the (b) polyphenylene ether may be a dispersed phase.

Note that the formation of a continuous phase by the (a) polyamide can be judged by shaping the resin composition to obtain a specimen, performing staining of the specimen so as to stain the (a) polyamide, and then observing the specimen under ×3,000 to ×25,000 magnification using a scanning electron microscope (SEM). More specifically, the formation of a continuous phase by the (a) polyamide can be judged by a method subsequently described in the EXAMPLES section.

[(c) Compatibilizer]

The (c) compatibilizer (hereinafter, also referred to simply as the “(c) component”) according to the present embodiment is a polyfunctional compound that interacts with the (b) polyphenylene ether, the (a) polyamide, or both thereof. This interaction may be chemical (for example, grafting) or physical (for example, modification of dispersed phase surface characteristics). In either case, the resultant polyamide-polyphenylene ether mixture displays improved compatibility.

Examples of compatibilizers that can be used in the present embodiment are described in detail in JP H8-48869 A, JP H9-124926 A, and so forth. Any of these commonly known compatibilizers can be used, and combined use thereof is also possible.

Examples of particularly suitable compatibilizers among these various types of compatibilizers include one or more selected from citric acid, maleic acid, itaconic acid, and anhydrides thereof. Of these examples, maleic anhydride and citric acid are more preferable.

The preferred content of the (c) compatibilizer in the present embodiment when the (a) polyamide and the (b) polyphenylene ether are taken to be 100 parts by mass, in total, is 0.01 parts by mass to 20 parts by mass, with 0.1 parts by mass to 10 parts by mass being more preferable, and 0.1 parts by mass to 5 parts by mass even more preferable.

[(d) Polyhydric Alcohol]

The (d) polyhydric alcohol (hereinafter, also referred to simply as the “(d) component”) according to the present embodiment is not specifically limited so long as it includes at least two hydroxyl groups and has a number-average molecular weight (Mn) of less than 500.

Specific examples include sugar alcohols such as sorbitol, mannitol, and pentaerythritol, sugar alcohol oligomers such as dipentaerythritol and tripentaerythritol, amide group-containing polyhydric alcohols such as N,N,N′,N′-tetrakis(2-hydroxyethyl)adipamide, N,N′-bis(2-hydroxyethyl)adipamide, and hexamethylene hydroxystearamide, amino group-containing polyhydric alcohols such as polyoxyethylene dodecylamine and polyoxyethylene octadecylamine, allylated ethers including a polyalkylene ether unit such as allylated ether of polyoxyethylene, polyoxyethylene alkyl ethers such as polyoxyethylene lauryl ether, polyoxyethylene tridodecyl ether, polyoxyethylene cetyl ether, polyoxyethylene stearyl ether, and polyoxyethylene oleyl ether, polyoxyethylene alkylphenyl ethers such as polyoxyethylene octylphenyl ether and polyoxyethylene nonylphenyl ether, and dihydric alcohols including a polyalkylene ether unit such as polyepichlorohydrin ether, polyoxyethylene bisphenol A ether, polyoxyethylene ethylene glycol, polyoxypropylene bisphenol A ether, and polyoxyethylene polyoxypropylene glycol ether.

The inclusion of the (d) component tends to give a good balance of fluidity during injection molding, heat resistance, and surface impact strength and also tends to result in fluidity and surface impact strength being retained when repeated extrusion is performed. Although the mechanism for this is not clear, it is presumed that by OH groups in the molecules acting to weaken intermolecular forces of the (a) polyamide, heat resistance is retained while improving fluidity, and surface impact strength is excellent due to increased binding strength at interfaces of the (a) polyamide and the (b) polyphenylene ether, and that through plasticization of the (b) polyphenylene ether, the dispersion size of the (b) polyphenylene ether dispersed phase is maintained when repeated extrusion is performed, and thus surface impact strength is retained.

In the present embodiment, the (d) polyhydric alcohol preferably includes one or a plurality of structures among an amide structure, an ether structure, and an ester structure from a viewpoint of compatibility.

From a viewpoint of improving fluidity during injection molding and surface impact strength and from a viewpoint of retaining heat resistance, the number-average molecular weight (Mn) of the (d) component is less than 500, preferably 400 or less, and particularly preferably 350 or less. Moreover, the number-average molecular weight (Mn) of the (d) component is preferably 130 or more, more preferably 180 or more, and even more preferably 250 or more.

Note that the number-average molecular weight (Mn) of the (d) component refers to a value that is measured by gel permeation chromatography (GPC).

The (d) component preferably includes at least one primary or secondary alcohol in a molecule thereof, and more preferably includes at least one primary alcohol in a molecule thereof. The inclusion of at least two primary alcohols in a molecule is even more preferable.

The content of the (d) polyhydric alcohol in the present embodiment when the (a) polyamide and the (b) polyphenylene ether are taken to be 100 parts by mass, in total, is 0.3 parts by mass to 5 parts by mass, preferably 0.5 parts by mass to 3 parts by mass, and more preferably 0.5 parts by mass to 2 parts by mass. When the content is within any of the ranges set forth above, it tends to be possible for additive effects of the (d) component to be sufficiently displayed and for bleed-out to be further inhibited.

[(e) Impact Modifier]

In the present embodiment, (e) an impact modifier (hereinafter, also referred to simply as the “(e) component”) may be further included. The (e) impact modifier according to the present embodiment is a non-hydrogenated block copolymer including at least one aromatic vinyl polymer block of mainly aromatic vinyl monomer units and at least one conjugated diene polymer block of mainly conjugated diene monomer units and/or is a hydrogenated product of this block copolymer.

Note that “mainly of aromatic vinyl monomer units” in relation to the aromatic vinyl polymer block means that aromatic vinyl monomer units constitute 50 mass % or more of the block. Aromatic vinyl monomer units more preferably constitute 70 mass % or more, even more preferably 80 mass % or more, and most preferably 90 mass % or more.

Likewise, “mainly of conjugated diene monomer units” in relation to the conjugated diene polymer block means that conjugated diene monomer units constitute 50 mass % or more of the block. Conjugated diene monomer units more preferably constitute 70 mass % or more, even more preferably 80 mass % or more, and most preferably 90 mass % or more.

Moreover, the aromatic vinyl polymer block may, for example, be a copolymer block having a small amount of a conjugated diene compound bonded at random in an aromatic vinyl polymer block. Likewise, the conjugated diene polymer block may, for example, be a copolymer block having a small amount of an aromatic vinyl compound bonded at random in a conjugated diene polymer block.

Examples of aromatic vinyl compounds that may be used to form aromatic vinyl monomer units include, but are not specifically limited to, styrene, α-methylstyrene, and vinyltoluene. One or more compounds selected from these aromatic vinyl compounds may be used, of which, styrene is particularly preferable.

Examples of conjugated diene compounds that may be used to form the conjugated diene polymer block include, but are not specifically limited to, butadiene, isoprene, piperylene, and 1,3-pentadiene. One or more compounds selected from these conjugated diene compounds may be used, of which, butadiene, isoprene, and combinations thereof are preferable.

In the microstructure of a conjugated diene polymer block section of the block copolymer, the content of 1,2-vinyl bonds or the total content of 1,2-vinyl bonds and 3,4-vinyl bonds (total vinyl bond content) is preferably 5% to 80%, more preferably 10% to 50%, and even more preferably 15% to 40%.

Note that the total vinyl bond content can be measured using an infrared spectrophotometer.

The non-hydrogenated block copolymer used to produce the hydrogenated product of the block copolymer (hydrogenated block copolymer) is preferably a block copolymer having the aromatic vinyl polymer block (a) and the conjugated diene polymer block (b) in a bonding structure selected from an a-b type structure, an a-b-a type structure, and an a-b-a-b type structure. Moreover, a combination of block copolymers having different bonding structures among those listed above may be used. In particular, a bonding structure selected from an a-b-a type structure and an a-b-a-b type structure is more preferable, and an a-b-a type bonding structure is even more preferable.

The (e) impact modifier used in the present embodiment is preferably a block copolymer that has been partially hydrogenated (i.e., a partially hydrogenated block copolymer).

The term “partially hydrogenated block copolymer” means that the non-hydrogenated block copolymer described above has been subjected to hydrogenation treatment so as to control aliphatic double bonds in the conjugated diene polymer block to within a range of more than 0% and less than 100%. The preferred hydrogenation percentage of the partially hydrogenated block copolymer is not less than 50% and less than 100%, with not less than 80% and less than 100% being more preferable, and not less than 98% and less than 100% most preferable. When the hydrogenation percentage is within any of these ranges, this enables particularly suitable use in electrical and electronic components such as connectors, breakers, and magnetic switches, electrical components in the automotive field, representative examples of which include relay blocks, and components for inside of aircraft.

The number-average molecular weight of the (e) impact modifier used in the present embodiment is preferably not less than 150,000 and less than 300,000. When the number-average molecular weight is within this range, it is possible to obtain a composition having excellent fluidity and impact strength.

A method for evaluating the number-average molecular weight of the (e) impact modifier in the resin composition is described below. First, a mixture of the (b) polyphenylene ether and the (e) impact modifier in the composition is separated as insoluble matter by using a solvent in which the (a) polyamide has good solubility and in which the (b) polyphenylene ether and the (e) impact modifier have poor solubility, such as formic acid aqueous solution, for example, and then the (e) impact modifier is separated from this insoluble matter using a solvent in which the (e) impact modifier has good solubility and the (b) polyphenylene ether has poor solubility, such as chloroform, for example. The separated (e) impact modifier is then measured using a gel permeation chromatography measurement device (GPC SYSTEM21 produced by Showa Denko K.K.) and a UV spectroscopic detector (UV-41 produced by Showa Denko K.K.) so as to determine the number-average molecular weight thereof as a standard polystyrene-equivalent value.

Note that the measurement conditions may be as follows.

Solvent: Chloroform

Temperature: 40° C.

Column: K-G, K-800RL, and K-800R at sample side and K-805L×2 at reference side

Flow rate: 10 mL/min

Measurement wavelength: 254 nm

Pressure: 15 kg/cm² to 17 kg/cm² Also note that low molecular weight components resulting from catalyst deactivation during polymerization may be detected during measurement of the number-average molecular weight, but these low molecular weight components are excluded from molecular weight calculation. The term “low molecular weight components” refers to components having a molecular weight of 3,000 or less. In general, the correct calculated molecular weight distribution (weight-average molecular weight/number-average molecular weight) is within a range of 1.0 to 1.1.

These block copolymers that can be used as the (e) impact modifier in the present embodiment may, so long as it is not contrary to the essence of the present disclosure, be used as a mixture of two or more types that differ in terms of bonding structure, differ in terms of the type of aromatic vinyl compound, differ in terms of the type of conjugated diene compound, differ in terms of the 1,2-vinyl bond content or the 1,2-vinyl bond content and 3,4-vinyl bond content, differ in terms of aromatic vinyl compound component content, or differ in terms of the hydrogenation percentage, for example.

Moreover, these block copolymers that can be used as the (e) impact modifier in the present embodiment may be fully or partially modified block copolymers.

The term “modified block copolymer” refers to a block copolymer that has been modified with at least one modifying compound having, in its molecular structure, at least one carbon-carbon double or triple bond and at least one carboxylic acid group, acid anhydride group, amino group, hydroxyl group, or glycidyl group.

The method by which the modified block copolymer is produced may be a method in which, in the presence or absence of a radical initiator, (1) the block copolymer is melt-kneaded and reacted with a modifying compound in a temperature range of not lower than the softening point of the block copolymer and not higher than 250° C., (2) the block copolymer and a modifying compound are reacted in solution at a temperature that is not higher than the softening point of the block copolymer, or (3) the block copolymer and a modifying compound are reacted without melting at a temperature that is not higher than the softening point of the block copolymer. Although any of these methods may be used, method (1) is preferable, and method (1) performed in the presence of a radical initiator is most preferable.

Note that the “at least one modifying compound having, in its molecular structure, at least one carbon-carbon double or triple bond and at least one carboxylic acid group, acid anhydride group, amino group, hydroxyl group, or glycidyl group” may be, but are not limited to, maleic acid, fumaric acid, chloromaleic acid, cis-4-cyclohexene-1,2-dicarboxylic acid, or acid anhydrides of these compounds; unsaturated alcohols having a general formula CₙHₙ₋₁OH or CₙH₂ₙ₋₃OH (n is a positive integer), such as allyl alcohol, 4-penten-1-ol, and 1,4-pentadien-3-ol, or unsaturated alcohols having a general formula of CₙH₂ₙ₋₅OH or CₙH₂ₙ₋₇OH (n is a positive integer); or allyl glycidyl ether, glycidyl acrylate, glycidyl methacrylate, or epoxidized natural fats and oils.

The preferred content of the (e) impact modifier in the present embodiment when the (a) polyamide and the (b) polyphenylene ether are taken to be 100 parts by mass, in total, is 3 parts by mass to 20 parts by mass, with 5 parts by mass to 15 parts by mass being more preferable, and 5 parts by mass to 10 parts by mass even more preferable.

[Flame Retardant]

In the present embodiment, a flame retardant may be further included. The flame retardant may by an inorganic flame retardant such as magnesium hydroxide or aluminum hydroxide; a nitrogen-containing cyclic compound such as melamine, cyanuric acid, or a salt of either thereof; an organophosphate ester such as triphenyl phosphate, triphenyl phosphate hydroxide, bisphenol A bis(diphenyl phosphate), or a derivative of any thereof; a phosphoric acid-based nitrogen-containing compound such as ammonium polyphosphate or melamine polyphosphate; a phosphazene-based compound described in JP H11-181429 A; a boric acid compound such as zinc borate; a silicone oil; red phosphorus; a phosphinate described in WO 2007/055147 A1; a mixture of any of the preceding examples; or the like. Of these flame retardants, nitrogen-containing cyclic compounds, organophosphate esters, phosphoric acid-based nitrogen-containing compounds, phosphazene-based compounds, boric acid compounds, silicone oils, and phosphinates are preferable, and bisphenol A bis(diphenyl phosphate) and derivatives thereof, phosphinates, and mixtures of any thereof are more preferable.

The content of the flame retardant in the resin composition according to the present embodiment is preferably 5 parts by mass to 30 parts by mass relative to 100 parts by mass, in total, of the (a) polyamide and the (b) polyphenylene ether. Particularly in a case in which the (e) impact modifier is included, the content of the flame retardant is preferably 5 parts by mass to 25 parts by mass relative to 100 parts by mass, in total, of the (a) polyamide, the (b) polyphenylene ether, and the (e) impact modifier.

[Coloring Agent]

In the present embodiment, the resin composition may be colored by any method without any specific limitations, and one or more coloring agents selected from commonly known organic dyes and pigments and inorganic pigments may be used.

Examples of organic dyes and pigments that may be used include azo-based pigments such as azo lake pigments, benzimidazolone pigments, diarylide pigments, and condensed azo pigments, phthalocyanine-based pigments such as phthalocyanine blue and phthalocyanine green, isoindolinone pigments, quinophthalone pigments, quinacridone pigments, perylene pigments, anthraquinone pigments, perinone pigments, condensed polycycle-based pigments such as dioxazine violet, azine-based pigments, and carbon black.

Among these organic dyes and pigments, it is preferable that the carbon black has a dibutyl phthalate (DBP) absorption of less than 250 mL/100 g, and preferably less than 150 mL/100 g, and has a nitrogen adsorption specific surface area of less than 900 m²/g, and more preferably less than 400 m²/g. When any of these ranges are satisfied, it is possible to obtain a composition that particularly excels in terms of coloring, mechanical strength, and flame retardance.

The DBP absorption and the nitrogen adsorption specific surface area referred to herein are values measured by methods defined in ASTM D2414 and JIS K6217, respectively.

Examples of azine-based dyes that may be used include Color Index Solvent Black 5 (C.I. 50415, CAS No. 11099-03-9), Solvent Black 7 (C.I. 50415:1, CAS No. 8005-20-5/101357-15-7), and Acid Black 2 (C.I. 50420, CAS No. 8005-03-6/68510-98-5).

Examples of inorganic pigments that may be used include metal oxides other than iron oxide, such as titanium oxide, zinc oxide, and chromium oxide and complex metal oxides such as titanium yellow, cobalt blue, and ultramarine.

The preferred additive amount of the above-described coloring agents when the entire resin composition is taken to be 100 mass % is preferably 2 mass % or less for carbon black, 2 mass % or less for an azine-based dye, and 8 mass % or less for an inorganic pigment. A more preferable amount is 1 mass % or less for carbon black, 1 mass % or less for an azine-based dye, and 5 mass % or less for an inorganic pigment.

Through addition in any of the additive amounts set forth above, the balance of impact resistance and mechanical characteristics can be maintained well. Moreover, in the case of an application in which flame retardance is required, the additive amounts set forth above are preferable from a viewpoint of flame retardance.

[Other Additives]

Besides the components described above, inorganic fillers and other additive components can be added as necessary at any stage in the present embodiment so long as the effects disclosed herein are not lost.

Examples of inorganic fillers that may be used include fiber, particle, plate, and needle-shaped inorganic reinforcing materials such as glass fiber, potassium titanate fiber, gypsum fiber, brass fiber, ceramic fiber, boron whisker fiber, mica, talc, silica, calcium carbonate, kaolin, calcined kaolin, wollastonite, xonotlite, apatite, glass beads, glass flake, and titanium oxide. Two or more of these inorganic fillers can be used in combination. Examples of more preferable inorganic fillers among these examples include glass fiber, carbon fiber, and glass beads. Moreover, an inorganic filler that has been surface treated by a commonly known method using a surface treatment agent such as a silane coupling agent may be used. However, since natural ore-based fillers often contain trace amounts of elemental iron, it is necessary to select and use a filler that has been purified to remove elemental iron.

The specific preferred additive amount of an inorganic filler when the entire resin composition is taken to be 100 mass % is 15 mass % or less for each inorganic filler, with 13 mass % or less being more preferable, and 10 mass % or less even more preferable.

Moreover, all inorganic filler is preferably 30 mass % or less, more preferably 25 mass % or less, and even more preferably 20 mass % or less when the entire resin composition is taken to be 100 mass %.

Examples of other additive components that may be used include other thermoplastic resins such as polyesters and polyolefins, plasticizers (low molecular weight polyolefins, polyethylene glycol, fatty acid esters, etc.), antistatic agents, nucleating agents, fluidity modifiers, anti-dripping agents, reinforcing agents, various peroxides, spreading agents, copper-based thermal stabilizers, organic thermal stabilizers, representative examples of which include hindered phenol-based oxidative degradation inhibitors, antioxidants, ultraviolet absorbers, and light stabilizers.

The specific preferred additive amount of other additive components when the entire resin composition is taken to be 100 mass % is 15 mass % or less for each additive component, with 13 mass % or less being more preferable, and 10 mass % or less even more preferable.

Moreover, all other additive components are preferably 30 mass % or less, more preferably 25 mass % or less, and even more preferably 20 mass % or less when the entire resin composition is taken to be 100 mass %.

With regards to evaluation of bleed-out of the resin composition according to the present embodiment, it is preferable that the surface of a shaped product is in a condition free of bleeding of additives after experimentation.

Note that evaluation of bleed-out is, more specifically, performed by a method subsequently described in the EXAMPLES section.

With regards to the falling weight impact strength (J) of the resin composition according to the present embodiment, a larger value indicates improvement of surface impact strength and is preferable.

Note that the falling weight impact strength refers to a value measured by a method subsequently described in the EXAMPLES section.

With regards to the melt volume-flow rate (cc/10 min) of the resin composition according to the present embodiment, a larger value indicates improvement of fluidity and is preferable.

Note that the melt volume-flow rate refers to a value measured by a method subsequently described in the EXAMPLES section.

With regards to the deflection temperature under load (DTUL) (° C.) of the resin composition according to the present embodiment, a larger value indicates improvement of heat resistance and is preferable.

Note that the deflection temperature under load (DTUL) refers to a value measured by a method subsequently described in the EXAMPLES section.

(Production Method of Resin Composition)

The specific processing machine that is used to obtain the composition according to the present embodiment is not specifically limited and may be a single screw extruder, a twin screw extruder, a roll, a kneader, a Brabender Plastograph, a Banbury mixer, or the like, for example. Of these processing machines, a twin screw extruder is preferable, and, in particular, a twin screw extruder including an upstream supply port and also including a downstream supply port at one or more locations is most preferable.

The melt-kneading temperature is preferably within a range of 280° C. to 340° C.

Although no specific limitations are placed on melt-kneading for obtaining the resin composition according to the present embodiment, it is preferable that the (b) polyphenylene ether and the (c) compatibilizer are melt-kneaded and that the (a) polyamide and the (d) polyhydric alcohol are subsequently added and melt-kneaded, for example. Moreover, in a case in which the resin composition contains the (e) impact modifier, the (e) impact modifier is preferably melt-kneaded with the (b) polyphenylene ether and the (c) compatibilizer in the melt-kneading described above.

More specifically, it is preferable that a twin screw extruder including a supply port at one location in an upstream section and one location in a midstream section (i.e., two locations in total) in terms of the direction of raw material flow is used, and that the (b) polyphenylene ether, the (c) compatibilizer, and optionally the (e) impact modifier are supplied from the upstream supply port and the (a) polyamide and the (d) polyhydric alcohol are supplied from the midstream supply port.

(Shaped Product and Production Method Thereof)

The resin composition according to the present embodiment can be shaped to produce shaped products having various shapes using shaping methods that are typically adopted for resin compositions such as injection molding, extrusion molding, press forming, blow molding, calendering, and casting.

In other words, a shaped product according to the present embodiment is a shaped product that includes the resin composition according to the present embodiment.

For example, the resin composition may be melted inside a cylinder of an injection molding machine in which the cylinder temperature is adjusted to within a range of not lower than the melting point of the (a) polyamide and not higher than 350° C. and may then be injected into a mold having a specific shape so as to produce a shaped product having a specific shape.

Alternatively, the resin composition may be melted inside an extruder in which the cylinder temperature is adjusted to within the range set forth above and may then be spun through a spinneret so as to produce a fibrous shaped product.

Further alternatively, the resin composition may be melted inside an extruder in which the cylinder temperature is adjusted to within the range set forth above and may then be extruded from a T-die so as to produce a shaped product having the form of a film or sheet.

The shaped product that is produced by such a method may be used with a coating layer of a paint, metal, other type of polymer, or the like formed on the surface thereof.

The resin composition according to the present embodiment can suitably be used as a shaping material for various components in automotive applications, electrical and electronic applications, industrial material applications, manufacturing material applications, daily and household good applications, and so forth.

### EXAMPLES

The following provides a more detailed description of the present disclosure through examples and comparative examples. However, the present disclosure is not limited to the following examples. Raw materials and evaluation methods used in the examples and comparative examples were as follows.

[Raw Materials]

(a) Polyamide

(a-1) Polyamide 6,6 having a VR value of 36, a terminal amino group concentration of 27 μmol/g, a terminal carboxyl group concentration of 81 μmol/g, and a terminal amino group concentration/terminal carboxyl group concentration ratio of 0.33

(a-2) Polyamide 6,6 having a VR value of 45, a terminal amino group concentration of 36 μmol/g, a terminal carboxyl group concentration of 90 μmol/g, and a terminal amino group concentration/terminal carboxyl group concentration ratio of 0.4

(a-3) Polyamide 6,6 having a VR value of 36, a terminal amino group concentration of 45 μmol/g, a terminal carboxyl group concentration of 80 μmol/g, and a terminal amino group concentration/terminal carboxyl group concentration ratio of 0.56

(a-4) Polyamide 6,6 having a VR value of 45, a terminal amino group concentration of 53 μmol/g, a terminal carboxyl group concentration of 95 μmol/g, and a terminal amino group concentration/terminal carboxyl group concentration ratio of 0.56

Note that VR of each (a) polyamide was measured in accordance with ASTM-D789 at 25° C. using a solution obtained by dissolving the (a) polyamide with a concentration of 8.4 mass % in 90 mass % formic acid (10 mass % water).

Also note that the terminal amino group concentration and terminal carboxyl group concentration of each (a) polyamide were measured by ¹H-NMR in accordance with a measurement method described in the examples of JP H7-228689 A.

(b) Polyphenylene Ether (PPE)

A polyphenylene ether resin obtained through oxidative polymerization of 2,6-xylenol was used. The polyphenylene ether resin had a reduced viscosity (measured for 0.5 g/dL chloroform solution at 30° C.) of 0.40 dL/g.

(c) Compatibilizer

Maleic anhydride (CRYSTAL MAN produced by NOF Corporation)

(d) Polyhydric Alcohol

Dipentaerythritol (Dipenta-90 produced by Perstorp; hexahydric alcohol including ether structure and having melting point of 217° C. to 222° C. and number-average molecular weight of 254.28)

(e) Impact Modifier

Copolymer formed of polystyrene-hydrogenated polybutadiene-polystyrene blocks (TAIPOL 6154-364-A produced by TSRC (Nantong) Industries Ltd.)

[Evaluation Methods]

Evaluation tests performed in the examples and comparative examples were conducted as described below.

(1) Formation of Continuous Phase by (a) Polyamide

Obtained resin composition pellets were supplied into a small-size injection molding machine (product name: IS-100GN; produced by Toshiba Machine Co., Ltd.) set to a cylinder temperature of 270° C. to 290° C. and were used to produce an ISO dumbbell for evaluation under conditions of a mold temperature of 90° C., an injection pressure of 70 MPa, an injection time of 20 s, and a cooling time of 15 s.

Three ISO dumbbells produced in this manner were stained as described below.

A specimen of 5 mm in length (resin flow direction) by 5 mm in width by 4 mm in thickness was cut out from a central section of each of the three ISO dumbbells. In order to add length to the specimen, a high-impact polystyrene specimen of 5 mm in length by 5 mm in width by 4 mm in thickness was adhered thereto by instant adhesive so as to produce a specimen for staining of 10 mm in length by 5 mm in width by 4 mm in thickness. A 1 mm-square flat surface for thin-film sectioning was prepared at a short side surface at the resin composition side of the specimen for staining using an ultramicrotome (ULTRACUT-N produced by Reichert-Nissei).

Next, the specimen for staining was soaked in 10 mass % phosphotungstic acid aqueous solution that was loaded into a heat-resistant vessel and was warmed at 80° C. for 4 hours in a water bath before being pulled out and cooled to normal temperature. Thereafter, the specimen for staining was removed from the heat-resistant vessel, was washed with water, and was dried.

Next, the aforementioned ultramicrotome, which had a diamond knife loaded with water installed, was used to cut out a 1 mm-square thin film of 85 nm in thickness, onto the water, from the flat surface for thin-film sectioning of the specimen for staining, and then this thin film was scooped up by Cu mesh for SEM observation. The Cu mesh having the thin-film thereon was arranged on a stainless steel net.

Through this staining operation, the (a) polyamide, (c) compatibilizer, and (d) polyhydric alcohol were stained such that they could be seen as white color upon observation using a scanning electron microscope. Moreover, the (b) polyphenylene ether and (e) impact modifier were not stained and thus could be seen as black color upon observation using a scanning electron microscope. Note that the (e) impact modifier is thought to have been contained in a dispersed phase formed by the (b) polyphenylene ether.

An image of the specimen that had been stained was captured using a scanning electron microscope (product name: SU8220; produced by Hitachi High-Technologies Corporation) with settings of a magnification of ×5,000 and an accelerating voltage of 4.0 kV. The obtained image was inspected, and a judgment of “Yes” was made in a case in which a phase containing the (a) polyamide formed a continuous phase (i.e., a white continuous phase was observed).

(2) Melt Volume-Flow Rate (MVR)

The MVR (cc/10 min) of obtained resin composition pellets was measured in accordance with ISO 1133 at 280° C. with a load of 2.16 kg.

A larger value was judged to indicate better fluidity.

(3) Fluidity after Repeated Extrusion

The MVR (cc/10 min) of resin composition pellets obtained after repeated extrusion in each of the following examples and comparative examples was measured in accordance with ISO 1133 at 280° C. with a load of 2.16 kg.

The fluidity after repeated extrusion was evaluated as “Excellent” in a case in which the retention ratio of MVR, compared to the pellets prior to repeated extrusion, was 90% or more, was evaluated as “Good” in a case in which this retention ratio was not less than 80% and less than 90%, and was evaluated as “Poor” in a case in which this retention ratio was less than 80%.

(4) Falling Weight Impact Strength

Obtained resin composition pellets were supplied into a small-size injection molding machine (product name: IS-100GN; produced by Toshiba Machine Co., Ltd.) set to a cylinder temperature of 270° C. to 290° C. and were molded into the form of a 75 mm×75 mm×3 mm flat plate under conditions of a mold temperature of 90° C., an injection pressure of 70 MPa, an injection time of 20 s, and a cooling time of 15 s.

The obtained flat plate was subjected to a falling weight impact test in accordance with JIS K 7211-1 in a 23° C. environment using a striker having a point diameter of 20 mm, and the total absorbed energy (J) required to break the specimen was measured.

A larger value was judged to indicate better surface impact strength.

(5) Falling Weight Impact Strength after Repeated Extrusion

Resin composition pellets obtained after repeated extrusion in each of the following examples and comparative examples were supplied into a small-size injection molding machine (product name: IS-100GN; produced by Toshiba Machine Co., Ltd.) set to a cylinder temperature of 270° C. to 290° C. and were molded into the form of a 75 mm×75 mm×3 mm flat plate under conditions of a mold temperature of 90° C., an injection pressure of 70 MPa, an injection time of 20 s, and a cooling time of 15 s.

The obtained flat plate was subjected to a falling weight impact test in accordance with JIS K 7211-1 in a 23° C. environment using a striker having a point diameter of 20 mm, and the total absorbed energy (J) required to break the specimen was measured.

The surface impact strength after repeated extrusion was evaluated as “Excellent” in a case in which the retention ratio of the total absorbed energy, compared to the pellets prior to repeated extrusion, was 90% or more, was evaluated as “Good” in a case in which this retention ratio was not less than 80% and less than 90%, and was evaluated as “Poor” in a case in which this retention ratio was less than 80%.

(6) Deflection Temperature Under Load (DTUL)

Obtained resin composition pellets were supplied into a small-size injection molding machine (product name: IS-100GN; produced by Toshiba Machine Co., Ltd.) set to a cylinder temperature of 270° C. to 290° C. and were used to produce an ISO dumbbell for evaluation under conditions of a mold temperature of 90° C., an injection pressure of 70 MPa, an injection time of 20 s, and a cooling time of 15 s. This ISO dumbbell was then cut to produce a test piece for deflection temperature under load (DTUL) measurement. This test piece for deflection temperature under load measurement was used to measure the deflection temperature under load DTUL (ISO 75, 0.45 MPa load).

A larger value was judged to indicate better heat resistance.

(7) Bleed-Out

Obtained resin composition pellets were supplied into a small-size injection molding machine (product name: IS-100GN; produced by Toshiba Machine Co., Ltd.) set to a cylinder temperature of 270° C. to 290° C. and were molded into the form of a 50 mm×90 mm×2 mm flat plate under conditions of a mold temperature of 80° C., an injection pressure of 70 MPa, an injection time of 10 s, and a cooling time of 15 s.

The shaped product that was produced in this manner was placed inside a 120° C. oven, and, once 100 hours had passed, was checked for deposition of powdered material (bleed-out) at the surface thereof.

An evaluation of “Excellent” was made in a case in which bleed-out did not occur at all, an evaluation of “Good” was made in a case in which bleed-out occurred over part of the surface, and an evaluation of “Poor” was made in a case in which bleed-out occurred over the entire surface.

### Examples 1 to 6 and Comparative Examples 1 to 4

A twin screw extruder ZSK-25 (produced by Coperion Inc.) was used as a resin composition production device. In this twin screw extruder, supply ports were provided at one location in an upstream section and at one location in a midstream section (i.e., at two locations in total) in terms of the direction of raw material flow. Moreover, vacuum vents were provided in a block directly before a cylinder block where the midstream supply port was located and in a cylinder block directly before a die. The supply method of raw material at the midstream supply port was a method of supply through an extruder side opening using a forced side feeder.

The twin screw extruder that had been set up as described above was supplied with (a) to (e) components in a chemical composition indicated in Table 1 by supplying the (b), (c), and (e) components from the upstream supply port and the (a) and (d) components from the midstream supply port, and these components were melt-kneaded under conditions of an extrusion temperature of 280° C. to 320° C., a screw speed of 400 rpm, and a discharge rate of 20 kg/hr so as to obtain resin composition pellets.

In order to adjust the moisture percentage of the obtained pellets, the pellets were dried in a dehumidifying dryer set to 120° C. after extrusion and were then loaded into an aluminum-coated moisture barrier bag. The moisture percentage of the pellets at this point was roughly 250 ppm to 400 ppm. These pellets were used to perform various evaluation tests.

Next, an operation of melt-kneading the obtained pellets in the twin screw extruder under conditions of an extrusion temperature of 280° C., a screw speed of 300 rpm, and a discharge rate of 20 kg/hr so as to obtain resin composition pellets was repeated twice, and thus pellets after repeated extrusion were obtained.

In order to adjust the moisture percentage of the obtained pellets, the pellets were dried in a dehumidifying dryer set to 120° C. after extrusion and were then loaded into an aluminum-coated moisture barrier bag. The moisture percentage of the pellets at this point was roughly 250 ppm to 400 ppm. These pellets were used to evaluate fluidity after repeated extrusion and to perform a test of falling weight impact strength after repeated extrusion.

Evaluation results for each resin composition are shown in Table 1.

TABLE 1

| | | | Example 1 | Example 2 | Example 3 | Example 4 | Example 5 | Example 6 |
|---|---|---|---|---|---|---|---|---|
| Resin | a-1 | Parts by mass | 63 | 63 | 63 | 63 | 63 | |
| composition | a-2 | Parts by mass | | | | | | 63 |
| | a-3 | Parts by mass | | | | | | |
| | a-4 | Parts by mass | | | | | | |
| | b | Parts by mass | 30 | 30 | 30 | 30 | 30 | 30 |
| | c | Parts by mass | 0.15 | 0.15 | 0.15 | 0.15 | 0.15 | 0.15 |
| | d | Parts by mass | 0.3 | 1 | 2.5 | 4.5 | 1 | 1 |
| | e | Parts by mass | 7 | 7 | 7 | 7 | 3 | 7 |
| Evaluation | Formation of continuous | — | Yes | Yes | Yes | Yes | Yes | Yes |
| | phase by (a) component | | | | | | | |
| | MVR | cm³/10 min | 36 | 50 | 80 | 120 | 53 | 27 |
| | DTUL | ° C. | 182 | 182 | 181 | 179 | 184 | 182 |
| | Falling weight impact strength | J | 64 | 64 | 60 | 55 | 56 | 63 |
| | MVR after repeated | cm³/10 min | Good | Excellent | Excellent | Excellent | Excellent | Good |
| | extrusion | | | | | | | |
| | Falling weight impact strength | J | Good | Excellent | Excellent | Excellent | Excellent | Good |
| | after repeated extrusion | | | | | | | |
| | Bleed-out | — | Excellent | Excellent | Excellent | Good | Excellent | Excellent |

| | | | Comparative | Comparative | Comparative | Comparative |
|---|---|---|---|---|---|---|
| | | | Example 1 | Example 2 | Example 3 | Example 4 |
| Resin | a-1 | Parts by mass | 63 | | | 63 |
| composition | a-2 | Parts by mass | | | | |
| | a-3 | Parts by mass | | 63 | | |
| | a-4 | Parts by mass | | | 63 | |
| | b | Parts by mass | 30 | 30 | 30 | 30 |
| | c | Parts by mass | 0.15 | 0.15 | 0.15 | 0.15 |
| | d | Parts by mass | 8 | 1 | 1 | |
| | e | Parts by mass | 7 | 7 | 7 | 7 |
| Evaluation | Formation of continuous | — | Yes | Yes | Yes | Yes |
| | phase by (a) component | | | | | |
| | MVR | cm³/10 min | 190 | 40 | 23 | 32 |
| | DTUL | ° C. | 172 | 181 | 182 | 181 |
| | Falling weight impact strength | J | 30 | 63 | 63 | 63 |
| | MVR after repeated | cm³/10 min | Excellent | Poor | Poor | Poor |
| | extrusion | | | | | |
| | Falling weight impact strength | J | Excellent | Poor | Poor | Poor |
| | after repeated extrusion | | | | | |
| | Bleed-out | — | Poor | Excellent | Excellent | Excellent |

### INDUSTRIAL APPLICABILITY

By using the resin composition according to the present disclosure, it is possible to obtain a resin composition with which bleed-out is inhibited, that has excellent heat resistance, fluidity, and surface impact strength, and that also excels in terms of shapeability for thin-walled components. Moreover, the resin composition according to the present disclosure can easily retain fluidity and surface impact strength even after repeated extrusion, and excels in terms of material recycling. Consequently, the resin composition according to the present disclosure has industrial applicability in terms that it can, for example, suitably be used as a shaping material for various components in automotive applications, electrical and electronic applications, industrial material applications, manufacturing material applications, daily and household good applications, and so forth.

1. A resin composition comprising:
(a) a polyamide;
(b) a polyphenylene ether;
(c) a compatibilizer for the (a) polyamide and the (b) polyphenylene ether; and
(d) a polyhydric alcohol including at least two hydroxyl groups and having a number-average molecular weight (Mn) of less than 500, wherein
content of the (d) polyhydric alcohol is 0.3 parts by mass to 5 parts by mass relative to 100 parts by mass, in total, of the (a) polyamide and the (b) polyphenylene ether,
a ratio of terminal amino group concentration relative to terminal carboxyl group concentration in the (a) polyamide, in terms of terminal amino group concentration/terminal carboxyl group concentration, is 0.3 to 0.5, and
the (a) polyamide forms a continuous phase.

2. The resin composition according to claim 1, wherein content of the (a) polyamide is 40 parts by mass to 90 parts by mass and content of the (b) polyphenylene ether is 10 parts by mass to 60 parts by mass relative to 100 parts by mass, in total, of the (a) polyamide and the (b) polyphenylene ether.

3. The resin composition according to claim 1, wherein the (a) polyamide has a formic acid relative viscosity (VR) of 30 to 40.

4. The resin composition according to claim 1, wherein the (a) polyamide is polyamide 6,6.

5. The resin composition according to claim 1, wherein the (d) polyhydric alcohol is dipentaerythritol.

6. The resin composition according to claim 1, further comprising, as (e) an impact modifier, either or both of a block copolymer including at least one block of mainly aromatic vinyl monomer units and at least one block of mainly conjugated diene monomer units and a hydrogenated product of the block copolymer.

7. A shaped product comprising the resin composition according to claim 1.

8. The shaped product according to claim 7, wherein the shaped product is a component for an automotive electrical or electronic application.

9. The resin composition according to claim 2, wherein the (a) polyamide has a formic acid relative viscosity (VR) of 30 to 40.

10. The resin composition according to claim 2, wherein the (a) polyamide is polyamide 6,6.

11. The resin composition according to claim 2, wherein the (d) polyhydric alcohol is dipentaerythritol.

12. The resin composition according to claim 2, further comprising, as (e) an impact modifier, either or both of a block copolymer including at least one block of mainly aromatic vinyl monomer units and at least one block of mainly conjugated diene monomer units and a hydrogenated product of the block copolymer.

13. A shaped product comprising the resin composition according to claim 2.

14. The shaped product according to claim 13, wherein the shaped product is a component for an automotive electrical or electronic application.

15. The resin composition according to claim 9, wherein the (a) polyamide is polyamide 6,6.

16. The resin composition according to claim 9, wherein the (d) polyhydric alcohol is dipentaerythritol.

17. The resin composition according to claim 9, further comprising, as (e) an impact modifier, either or both of a block copolymer including at least one block of mainly aromatic vinyl monomer units and at least one block of mainly conjugated diene monomer units and a hydrogenated product of the block copolymer.

18. A shaped product comprising the resin composition according to claim 9.

19. The shaped product according to claim 18, wherein the shaped product is a component for an automotive electrical or electronic application.
